(19) United States
(12) Patent Application Publication
(10) Pub. No.: US 2026/0074100 A1
(43) Pub. Date: Mar. 12, 2026

(54) Soft Magnetic Powder, Dust Core, Magnetic Element, And Electronic Device

(71) Applicant: SEIKO EPSON CORPORATION, Tokyo (JP)

(72) Inventors: Toshiki SANO, Hachinohe (JP); Yuto OKUDERA, Hachinohe (JP); Junya ABE, Hachinohe (JP); Yoshihiro SHIMOTORI, Hachinohe (JP)

(21) Appl. No.: 19/321,625

(22) Filed: Sep. 8, 2025

(30) Foreign Application Priority Data
Sep. 9, 2024 (JP) 2024-154965

(51) Int. Cl. H01F 1/147; B22F 1/05; B22F 1/065; B22F 9/08; C22C 38/06; C22C 38/34; H01F 27/255

(52) U.S. Cl. CPC H01F 1/14766; B22F 1/05; B22F 1/065; B22F 9/082; C22C 38/06; C22C 38/34; H01F 27/255; B22F 2009/0828; B22F 2301/35; B22F 2304/10; B22F 2999/00; C22C 2202/02

(57) ABSTRACT

A soft magnetic powder contains: Fe as a main component; Si having a content of 2.5 mass % or more and 7.5 mass % or less; Cr having a content of 0.5 mass % or more and 10.0 mass % or less; Al having a content of 0.05 mass % or more and 0.50 mass % or less; C having a content of 0.005 mass % or more and 0.050 mass % or less; and an impurity. When 0.5 g of the soft magnetic powder weighed is used as a test object, the test object is placed in a cylinder having an inner diameter of 8 mm and an axis in an up-down direction, and a withstand voltage is measured in a state in which a load of 20 kgf (196 N) is applied to the test object by sandwiching the test object between electrodes from above and below, the withstand voltage is 400 V or more.

The present application is based on, and claims priority from JP Application Serial Number 2024-154965, filed Sep. 9, 2024, the disclosure of which is hereby incorporated by reference herein in its entirety.

### BACKGROUND

### 1. Technical Field

The present disclosure relates to a soft magnetic powder, a dust core, a magnetic element, and an electronic device.

### 2. Related Art

JP-A-2020-145405 discloses a soft magnetic alloy powder containing Fe and Si, and at least one of Cr and Al as elements, the soft magnetic alloy powder including, on a surface of a grain, an oxide film containing at least one of Cr and Al in addition to Si as elements, in which a mass ratio of these contained elements is higher than that of an alloy portion in the grain, and a content of Si represented by a mass ratio is higher than a total of Cr and Al.

According to such a soft magnetic alloy powder, since a filling rate can be increased, a pressing pressure can be reduced, and for example, in a coil component having an internal conductor, damage to the conductor can be prevented.

JP-A-2020-145405 is an example of the related art.

In the soft magnetic alloy powder described in JP-A-2020-145405, there is room for improvement in filling properties during compacting. Meanwhile, when the filling properties during compacting is increased, a distance between particles is shortened, and thus insulation properties of a green compact is likely to decrease.

Therefore, an object is to implement a soft magnetic powder capable of enhancing filling properties during compacting, improving magnetic properties, and producing a green compact capable of coping with a high voltage.

### SUMMARY

A soft magnetic powder according to an application example of the present disclosure contains:
Fe as a main component;
Si having a content of 2.5 mass % or more and 7.5 mass % or less;
Cr having a content of 0.5 mass % or more and 10.0 mass % or less;
Al having a content of 0.05 mass % or more and 0.50 mass % or less; C having a content of 0.005 mass % or more and 0.050 mass % or less; and
an impurity,
when 0.5 g of the soft magnetic powder weighed is used as a test object, the test object is placed in a cylinder having an inner diameter of 8 mm and an axis in an up-down direction, and a withstand voltage is measured in a state in which a load of 20 kgf (196 N) is applied to the test object by sandwiching the test object between electrodes from above and below, the withstand voltage is 400 V or more.

A dust core according to an application example of the present disclosure includes:
the soft magnetic powder according to the application example of the present disclosure.

A magnetic element according to an application example of the present disclosure includes:
a dust core according to the application example of the present disclosure.

An electronic device according to an application example of the present disclosure includes:
the magnetic element according to the application example of the present disclosure.

### BRIEF DESCRIPTION OF THE DRAWINGS

FIG. 1 is a plan view schematically showing a coil component of a toroidal type.

FIG. 2 is a transparent perspective view schematically showing a coil component of a closed magnetic circuit type.

FIG. 3 is a perspective view showing a mobile personal computer which is an electronic device according to an embodiment.

FIG. 4 is a plan view showing a smartphone which is an electronic device according to the embodiment.

FIG. 5 is a perspective view showing a digital still camera which is an electronic device according to the embodiment.

FIG. 6 shows Table 1 indicating configurations, production conditions, and evaluation results of soft magnetic powders of respective sample Nos.

FIG. 7 shows Table 2 indicating the configurations, the production conditions, and the evaluation results of the soft magnetic powders of respective sample Nos.

### DESCRIPTION OF EMBODIMENTS

Hereinafter, a soft magnetic powder, a dust core, a magnetic element, and an electronic device of the present disclosure will be described in detail based on a preferred embodiment shown in the accompanying drawings.

### 1. Soft Magnetic Powder

A soft magnetic powder according to the embodiment is a metal powder exhibiting soft magnetism. The soft magnetic powder can be applied to various uses, for example, production of various green compacts such as a dust core and an electromagnetic wave absorber by binding particles.

### 1.1. Composition

The soft magnetic powder contains Fe (iron) as a main component, Si (silicon) having a content of 2.5 mass % or more and 7.5 mass % or less, Cr (chromium) having a content of 0.5 mass % or more and 10.0 mass % or less, Al (aluminum) having a content of 0.05 mass % or more and 0.50 mass % or less, C (carbon) having a content of 0.005 mass % or more and 0.030 mass % or less, and impurities. In addition, when 0.5 g of the soft magnetic powder weighed is used as a test object, the test object is placed in a cylinder having an inner diameter of 8 mm and an axis in an up-down direction, and the withstand voltage is measured in a state in which a load of 20 kgf (196 N) is applied to the test object by sandwiching the test object between electrodes from above and below, a withstand voltage is 400 V or more.

According to such a configuration, since the optimum amounts of Al and C are added to a composition of a Fe—Si—Cr system forming the soft magnetism, the insulation properties of a surface is enhanced while sphericity is enhanced, and a good withstand voltage can be implemented even during compacting. Therefore, it is possible to implement a soft magnetic powder capable of enhancing the filling properties during the compacting, improving magnetic properties, and producing a green compact having a good withstand voltage.

Hereinafter, each component will be sequentially described. Fe is a main component of the soft magnetic powder. The main component refers to an element having a highest content in terms of an atomic ratio. Fe greatly affects basic magnetic properties of the soft magnetic powder.

The content of Fe is not particularly limited, and is preferably 80.0 mass % or more, and more preferably 85.0 mass % or more.

The content of Si is 2.5 mass % or more and 7.5 mass % or less, preferably 2.7 mass % or more and 5.0 mass % or less, and more preferably 3.0 mass % or more and 4.5 mass % or less. When the content of Si is within the above range, a green compact having a higher permeability can be obtained. When the content of Si is less than the lower limit value, magnetic properties such as a permeability and a DC superimposition characteristic decrease. On the other hand, when the content of Si is more than the upper limit value, the soft magnetic powder is hard and the filling properties decrease, and thus a density of the green compact decreases.

The content of Cr is 0.5 mass % or more and 10.0 mass % or less, preferably 0.6 mass % or more and 6.0 mass % or less, and more preferably 0.8 mass % or more and 3.0 mass % or less. When the content of Cr is within the above range, an oxidation resistance of the soft magnetic powder is enhanced, and an amount of oxide is optimized. Accordingly, it is possible to ensure the insulation properties between particles during compacting while enhancing a weather resistance of the soft magnetic powder. As a result, it is possible to implement a soft magnetic powder capable of improving magnetic properties during compacting and producing a green compact capable of coping with a high voltage. When the content of Cr is less than the lower limit value, the oxidation resistance of the soft magnetic powder decreases. On the other hand, when the content of Cr is more than the above upper limit value, the amount of Fe relatively decreases and the amount of oxide is excessive, and magnetic properties such as the permeability, the DC superimposition characteristics, and a saturation magnetic flux density decrease.

A mass ratio of the content of Si to the content of Cr is defined as Si/Cr. The mass ratio Si/Cr is preferably 0.5 or more and 5.0 or less, more preferably 1.0 or more and 4.5 or less, and further preferably 1.5 or more and 4.0 or less. When the mass ratio Si/Cr is within the above range, a balance between the content of Si and the content of Cr can be optimized. Accordingly, it is possible to implement a soft magnetic powder capable of producing a green compact having good magnetic properties without decreasing the withstand voltage.

The content of Al is 0.05 mass % or more and 0.50 mass % or less, preferably 0.07 mass % or more and 0.40 mass % or less, and more preferably 0.09 mass % or more and 0.30 mass % or less. When the content of Al is within the above range, the soft magnetic powder can be spheroidized. When the content of Al is within the above range, similarly to Cr, the oxidation resistance of the soft magnetic powder is enhanced, and the amount of oxide is optimized. Accordingly, it is possible to ensure the insulation properties between particles during compacting while enhancing a weather resistance of the soft magnetic powder. As a result, it is possible to implement a soft magnetic powder capable of improving magnetic properties during compacting and producing a green compact capable of coping with a high voltage. In addition, when the content of Al is within the above range, the surface tension of the molten metal can be reduced, and thus spheroidization when pulverized is easily achieved. Accordingly, a soft magnetic powder capable of producing a green compact having good filling properties and high density and good magnetic properties is obtained. When the content of Al is less than the above lower limit value, the filling properties, the oxidation resistance, and the withstand voltage during compacting of the soft magnetic powder decrease. On the other hand, when the content of Al is more than the above upper limit value, the amount of Fe relatively decreases and the amount of oxide is excessive, and magnetic properties such as the permeability, the DC superimposition characteristics, and the saturation magnetic flux density decrease.

The content of C is 0.005 mass % or more and 0.050 mass % or less, preferably 0.010 mass % or more and 0.045 mass % or less, and more preferably 0.015 mass % or more and 0.040 mass % or less. When the content of C is within the above range, the hardness of the particles of the soft magnetic powder can be optimized. Accordingly, a soft magnetic powder showing appropriate deformability during compacting while ensuring appropriate fluidity before being compacted is obtained. Such a soft magnetic powder has good filling properties, thereby contributing to the production of a green compact having high density and good magnetic properties. When the content of C is less than the above lower limit value, the hardness of the particles is insufficient, and the number of irregularly shaped particles increases at a stage before the powder is compacted. Therefore, fluidity of the soft magnetic powder decreases, and the filling properties during compacting decreases. On the other hand, when the content of C is more than the above upper limit value, the hardness of the particles is excessive. Therefore, the filling properties of the soft magnetic powder during compacting decreases.

The mass ratio of the content of C to the content of Al is defined as C/Al. The mass ratio C/Al is preferably 0.010 or more and 0.500 or less, more preferably 0.050 or more and 0.450 or less, and further preferably 0.080 or more and 0.400 or less. When the mass ratio C/Al is within the above range, the balance between the content of C and the content of Al can be optimized. Accordingly, it is possible to achieve both the spheroidization of the particles by the addition of Al and the optimization of the hardness of the particles by the addition of C with a more optimal balance. As a result, a soft magnetic powder having particularly good filling properties during compacting is obtained.

When a mass ratio C/Al is less than the above lower limit value, a balance between the content of C and the content of Al is lost, and thus hardness of the particles may be insufficient, and the fluidity of the soft magnetic powder may be reduced or the magnetic properties may decrease. On the other hand, when the mass ratio C/Al is more than upper limit value, the balance between the content of C and the content of Al is lost, so that the hardness of the particles is excessive, and there is a concern that the filling properties of the soft magnetic powder may be lowered or the spheroidization of the particles may be insufficient.

The soft magnetic powder may contain other elements as impurities in addition to the above elements. The impurities refer to elements other than the above-described elements that are inevitably mixed.

A concentration of the impurities is preferably 0.10 mass % or less, and more preferably 0.05 mass % or less for each element. A total concentration of the impurities is preferably 1.00 mass % or less. Within the range, other elements can be contained without affecting effects of the soft magnetic powder, and thus the impurities are allowed to be contained.

The soft magnetic powder according to the embodiment may contain oxygen as an impurity. An oxygen content in the soft magnetic powder is preferably 3000 ppm or less, more preferably 2000 ppm or less, and still more preferably 1500 ppm or less in terms of a mass ratio. Accordingly, since deterioration in a particle shape due to surface adhesion of the oxide is prevented, a soft magnetic powder having high filling properties during compacting is obtained. In addition, since a decrease in metal occupancy in the green compact can be prevented, a green compact having good magnetic properties can be obtained. On the other hand, the lower limit value may not be set, but from the viewpoint of ensuring the insulation properties between particles, the lower limit value of an oxygen content is preferably 300 ppm or more, and more preferably 500 ppm or more. Accordingly, it is possible to sufficiently ensure the insulation properties between the particles and to obtain a green compact having a good withstand voltage.

The above composition is identified by the following analysis method.

Examples of the analysis method include iron and steel-atomic absorption spectrometry defined in JIS G 1257:2000, iron and steel-ICP emission spectrometry defined in JIS G 1258:2007, iron and steel-spark discharge emission spectrometry defined in JIS G 1253:2002, iron and steel-fluorescent X-ray spectrometry defined in JIS G 1256:1997, and gravimetric, titration and absorption spectrometric methods defined in JIS G 1211 to JIS G 1237.

Specifically, examples thereof include a solid-state optical emission spectrometer manufactured by SPECTRO, in particular a spark discharge optical emission spectrometer, model: SPECTROLAB, type: LAVMB08A, and an ICP device CIROS120 manufactured by Rigaku Corporation.

In particular, when identifying carbon (C) and sulfur(S), an infrared absorption method after combustion in a current of oxygen (combustion in high frequency induction furnace) defined in JIS G 1211:2011 is also used. Specifically, examples thereof include a carbon-sulfur analyzer CS-200 manufactured by LECO Corporation.

Further, when nitrogen (N) and oxygen (O) are identified, methods for determination of nitrogen content for an iron and steel defined in JIS G 1228:1997 and general rules for determination of oxygen in metal materials defined in JIS Z 2613:2006 are also used. Specifically, examples thereof include an oxygen/nitrogen analyzer TC-300/EF-300 manufactured by LECO Corporation, and an oxygen/nitrogen/hydrogen analyzer ONH836 manufactured by LECO Corporation.

### 1.2. Powder Properties

An average particle diameter of the soft magnetic powder according to the embodiment is 2.0 μm or more and 12.0 μm or less, preferably 4.0 μm or more and 10.0 μm or less, and more preferably 5.0 μm or more and 9.5 μm or less. Accordingly, a soft magnetic powder capable of producing a green compact having a high filling properties during compacting and a good withstand voltage is obtained.

When an average particle diameter of the soft magnetic powder is less than the lower limit value, the soft magnetic powder tends to aggregate, the filling properties decrease, and the density of the green compact decreases. On the other hand, when the average particle diameter of the soft magnetic powder is more than the above upper limit value, the withstand voltage of the green compact may decrease.

The average particle diameter refers to a particle diameter D50 when a cumulative frequency is 50% from a small diameter side in a cumulative particle size distribution on a volume basis of the soft magnetic powder obtained using a laser diffraction type particle size distribution measurement device.

When the soft magnetic powder according to the embodiment is subjected to particle size classification, the obtained classified products preferably satisfy the following predetermined relationship.

Specifically, first, the soft magnetic powder is classified with a first sieve having an opening of 45 μm. The classified product that passes through the first sieve is −45 particles.

Next, the −45 particles are classified with a second sieve having an opening of 32 μm. The classified product remaining on the second sieve is +32 particles, and the classified product passes through the second sieve is −32 particles.

Next, the −32 particles are classified with a third sieve having an opening of 16 μm. The classified product remaining on the third sieve is +16 particles, and the classified product passing through the third sieve is −16 particles.

Here, an average circularity of the −45 particles is defined as X. The average circularity of +32 particles is denoted by Y1, the average circularity of +16 particles is denoted by Y2, and the average circularity of −16 particles is denoted by Y3.

The soft magnetic powder according to the embodiment preferably satisfies the following formulas (1), (2), and (3).

Y1=αx (1)

Y2=βX (2)

Y3=γX (3)

(A coefficient α in the above formula (1), a coefficient β in the above formula (2), and a coefficient γ in the above formula (3) are each 0.95 or more and 1.05 or less.)

By satisfying such a relationship, a soft magnetic powder having particularly good filling properties is obtained. That is, in order to enhance the filling properties of the soft magnetic powder, it is particularly required that the particles are spheroidized regardless of the particle size, a particle size distribution is optimized, and the like. In the soft magnetic powder according to the embodiment, not only the spheroidization is achieved by optimizing the composition, but also a difference in a degree of spheroidization between the classified products is kept to be small by the improvement of a production method to be described later. Therefore, the soft magnetic powder according to the embodiment has particularly high filling properties during compacting.

The average circularity X is preferably 0.80 or more and 0.95 or less, preferably 0.82 or more and 0.92 or less, and more preferably 0.85 or more and 0.90 or less. Accordingly, a soft magnetic powder having particularly good filling properties during compacting is obtained. In addition, when an insulating coating film is formed at a particle surface of the soft magnetic powder, the film can be formed uniformly and evenly. Accordingly, it is possible to produce a green compact having excellent insulation properties between particles. In addition, by forming the film uniformly and evenly, a specific surface area can be reduced, and thus an amount of a binder covering a surface can also be reduced. Therefore, the amount of the binder that binds the particles can be small, and thus the magnetic properties of the green compact can be enhanced also from this viewpoint.

When each of the average circularities X, Y1, Y2, and Y3 is less than the above lower limit value, the filling properties of the soft magnetic powder during compacting may decrease, or the uniformity of a film thickness of the insulating coating film may decrease. On the other hand, when each of the average circularities X, Y1, Y2, and Y3 is more than the above upper limit value, it may be difficult to produce the soft magnetic powder.

The average circularities X, Y1, Y2, and Y3 of the soft magnetic powder are measured as follows.

First, an image (secondary electron image) of the soft magnetic powder is captured using a scanning electron microscope (SEM). Next, the obtained image is read into image processing software. As the image processing software, for example, image analysis type particle size distribution measurement software “Mac-View” manufactured by Mountech Co., Ltd. is used. An imaging magnification is adjusted such that 50 or more and 100 or less particles appear in one image. Then, a plurality of images are acquired to obtain images of a total of 300 or more particles.

Next, a circularity of the images of 300 or more particles is calculated using software, and an average value is obtained. The obtained average value is the average circularity of the soft magnetic powder. When a circularity is represented by e, an area of a particle image is represented by S, and a perimeter of the particle image is represented by L, the circularity e is obtained using the following formula.

e=4πS/L²

In the soft magnetic powder according to the embodiment, a Vickers hardness of a cross section of the particle is preferably 250 or more and 400 or less, and more preferably 275 or more and 350 or less. When the Vickers hardness of the cross section of the particle is within the above range, the surface of the particle is appropriately likely to be deformed when the soft magnetic powder is compacted. Accordingly, the filling properties of the soft magnetic powder during compacting can be enhanced. When the Vickers hardness is less than the above lower limit value, the surface of the particles is likely to be excessively deformed, and the fluidity of the soft magnetic powder may decrease. On the other hand, when the Vickers hardness is more than the above upper limit value, the surface of the particles is less likely to be deformed, and the filling properties of the soft magnetic powder during compacting may decrease.

The Vickers hardness of the cross section of the particle is measured as follows.

First, the cross section of the particle is exposed and observed with an optical microscope. Next, the Vickers hardness at the center of the cross section is measured by a hardness tester. A Vickers hardness tester is used as the hardness tester. A measurement load is 5 kgf (49 N), and a load holding time is 10 seconds.

A specific surface area of the soft magnetic powder according to the embodiment is preferably 0.190 m²/g or more and 0.350 m²/g or less, and more preferably 0.210 m²/g or more and 0.300 m²/g or less. When the specific surface area is within the above range, the filling properties of the soft magnetic powder are improved, and the density of the green compact can be enhanced. When the specific surface area is less than the above lower limit value, the filling properties of the soft magnetic powder may decrease by the increase in the particle diameter. On the other hand, when the specific surface area is more than the above upper limit value, the particles of the soft magnetic powder are likely to aggregate, so that the filling properties may decrease and the density of the green compact decrease.

The specific surface area is obtained using a BET method. As a specific surface area measurement device, for example, a BET type specific surface area measurement device HM1201-010 manufactured by Mountech Co., Ltd. may be used, and a specimen amount is 5 g.

A tap density of the soft magnetic powder according to the embodiment is preferably 4.50 g/cm³ or more and 5.10 g/cm³ or less, and more preferably 4.65 g/cm³ or more and 5.00 g/cm³ or less. When the tap density is within the above range, a soft magnetic powder having particularly good filling properties is obtained. Accordingly, it is possible to produce a green compact having high density and good magnetic properties. When the tap density is less than the lower limit value, the filling properties of the soft magnetic powder decrease, and the density of the green compact may decrease. On the other hand, when the tap density is more than the upper limit value, a degree of difficulty in producing the soft magnetic powder may increase.

The tap density of the soft magnetic powder is measured by a powder characteristic evaluation device. As the powder characteristic evaluation device, Powder Tester (registered trademark) PT-X manufactured by Hosokawa Micron Corporation is used.

A relative density of the green compact obtained by compacting the soft magnetic powder according to the embodiment at a pressure of 588.4 MPa is preferably 79.0% or more, and more preferably 80.0% or more and 85.0% or less. Accordingly, a soft magnetic powder having particularly good filling properties and excellent manufacturability is obtained.

The relative density of the green compact is obtained by dividing the density obtained by dividing a weight of the green compact compacted under the above pressure by a volume calculated from an outer dimension by a true density of the soft magnetic powder.

### 1.3. Electrical Properties and Magnetic Properties

The soft magnetic powder according to the embodiment has a withstand voltage of 400 V or more and preferably 450 V or more and 4000 V or less when 0.5 g of the weighed soft magnetic powder is used as a test object, the test object is placed in a cylinder having an inner diameter of 8 mm and an axis in the up-down direction, and the withstand voltage is measured in a state in which a load of 20 kgf (196 N) is applied to the test object by sandwiching the test object between electrodes from above and below. The soft magnetic powder in which the withstand voltage of the test object is within such a range contributes to implementation of a magnetic element having a large rated voltage even in a small size.

When the withstand voltage is less than the lower limit value, the rated voltage of the magnetic element may not be sufficiently enhanced. On the other hand, the withstand voltage may be more than the upper limit value, but in this case, a variation in the withstand voltage of the magnetic element may increase.

A method for measuring the withstand voltage is as follows.

First, a soft magnetic powder having a mass of 0.5 g is weighed as a test object. Next, a resin cylinder having an axis in the up-down direction and an inner diameter of 8 mm is prepared, and a test object is placed therein. Next, the test object is sandwiched between two electrodes made of brass in the up-down direction. The electrode has a cylindrical shape having an outer diameter (about 8 mm) in sliding contact with an inner surface of the cylinder. Next, a DC voltage is applied between the electrodes in a state in which a load of 20 kgf (196 N) is applied to the test object via the electrodes. Then, while increasing the voltage in increments of 50 V, an electrical resistance value between the electrodes is measured with a digital multimeter. Further, the voltage when the electrical resistance value is 1 MΩ or less is defined as the withstand voltage. For example, when the electrical resistance value is 1 MΩ or less when the voltage is 550 V, a withstand voltage is set to 500 V.

A saturation magnetic flux density Bs of the soft magnetic powder according to the embodiment is preferably 1.80 T or more, and more preferably 1.90 T or more. Accordingly, a soft magnetic powder capable of producing a magnetic element that is unlikely to be saturated even at a high current is obtained.

The saturation magnetic flux density Bs of the soft magnetic powder is measured by the following method.

First, a true density ρ g/cm³ of the soft magnetic powder is measured by a fully automatic gas displacement densitometer, AccuPyc1330 manufactured by Micromeritics Corporation. A method for measuring the true density ρ is not limited thereto. Next, a maximum magnetic moment Mm [emu/g] of the soft magnetic powder is measured by a vibrating sample magnetometer, VSM system manufactured by Tamakawa Co., Ltd., TM-VSM1230-MHHL. Then, the saturation magnetic flux density Bs [T] is calculated by the following formula.

Bs=4π/10000×ρ×Mm

### 2. Production Method for Soft Magnetic Powder

Next, an example of a method for producing the above soft magnetic powder will be described.

The soft magnetic powder may be a powder produced using any method. Examples of the method for producing the soft magnetic powder include a pulverization method, in addition to various atomization methods such as a water atomization method, a rotary water jet atomization method, and a gas atomization method. Among these, a powder produced by an atomization method is preferably used as the soft magnetic powder. According to the atomization method, a metal powder having a particle shape closer to a perfect sphere can be efficiently produced.

The atomization method is a method for producing a metal powder by causing a molten metal to collide with a liquid or a gas ejected at a high speed to atomize and cool the molten metal. In the atomization method, since the molten metal is more spherical in the process of solidification after the molten metal is atomized, a particle closer to a perfect sphere can be produced.

The water atomization method is a method of producing a metal powder from a molten metal by using a liquid such as water as a coolant, spraying the liquid in an inverted conical shape to converge the liquid to one point, and causing the molten metal to flow down toward the convergence point and to undergo collision.

The rotary water jet atomization method is a method for producing a metal powder by supplying a coolant along an inner peripheral surface of a cooling cylinder, swirling the coolant along the inner peripheral surface, spraying a jet of a liquid or a gas to a molten metal, and merging the scattered molten metal into the coolant.

The gas atomization method is a method for producing a metal powder from a molten metal by using a gas as a cooling medium, injecting the gas in an inverted conical shape that converges the gas to one point, and causing the molten metal to flow down toward the convergence point and undergo collision.

A casting temperature that is a melting temperature is preferably set, with respect to a melting point Tm [° C.] of a constituent material of the soft magnetic powder, to Tm+200° C. or higher, more preferably Tm+220° C. or higher and Tm+350° C. or lower, and still more preferably Tm+250° C. or higher and Tm+300° C. or lower. Accordingly, it is possible to ensure a time during which the molten metal is present longer than that in the related art when the molten metal is atomized and solidified using various atomization methods. Accordingly, the particles are spheroidized.

In the atomization method, the molten metal is allowed to flow down from a narrow nozzle hole, and an obtained fine stream of the molten metal is allowed to collide with a fluid jet. An inner diameter of the nozzle hole for dispensing the molten metal is not particularly limited, and is preferably 2.5 mm or less, more preferably 0.3 mm or more and 2.0 mm or less, and still more preferably 0.5 mm or more and 1.5 mm or less. Accordingly, the fluid jet can be easily and uniformly applied to the molten metal, and thus liquid droplets having an appropriate size can be easily and uniformly scattered. As a result, a spheroidized soft magnetic powder can be easily produced regardless of the particle size. In addition, since a cooling rate is relatively high, the particle diameter of the crystal grains formed inside the particles can be kept to be small, and the Vickers hardness of the soft magnetic powder can be easily enhanced.

The produced soft magnetic powder may be classified as necessary. Examples of classification methods include dry classification such as sieving classification, inertial classification, and centrifugal classification, and wet classification such as sedimentation classification.

### 3. Dust Core and Magnetic Element

Next, the dust core and the magnetic element according to the embodiment will be described.

The magnetic element according to the embodiment can be applied to various magnetic elements including a magnetic core, such as choke coils, an inductor, a noise filter, a reactor, a transformer, a motor, an actuator, a solenoid valve, and a generator. The dust core according to the embodiment can be applied to a magnetic core provided to these magnetic elements.

Hereinafter, two types of coil components will be representatively described as examples of the magnetic element.

### 3.1. Toroidal Type

First, a toroidal type coil component, which is an example of the magnetic element according to the embodiment, will be described.

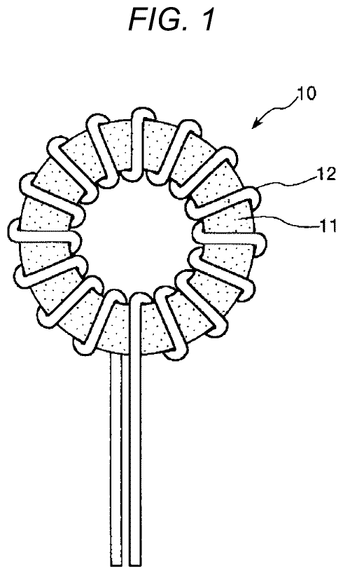

FIG. 1 is a plan view schematically showing the coil component of the toroidal type.

A coil component 10 shown in FIG. 1 includes a ring-shaped dust core 11 and a conductive wire 12 wound around the dust core 11. Such the coil component 10 is generally called a toroidal coil.

The dust core 11 is obtained by mixing the soft magnetic powder according to the embodiment and a binder, supplying the obtained mixture to a mold, and pressing and molding the mixture. Therefore, the dust core 11 is a green compact containing the soft magnetic powder according to the embodiment. In such the dust core 11, since the filling properties are enhanced, a high density is achieved. Accordingly, the coil component 10 having improved magnetic properties and coping with a high voltage is obtained. Therefore, when the coil component 10 is mounted on an electronic device or the like, it is possible to achieve high performance and miniaturization of the electronic device or the like.

Examples of a constituent material of the binder used for producing the dust core 11 include organic materials such as silicone-based resins, epoxy-based resins, phenol-based resins, polyamide-based resins, polyimide-based resins, and polyphenylene sulfide-based resins, and inorganic materials such as phosphates such as magnesium phosphate, calcium phosphate, zinc phosphate, manganese phosphate, and cadmium phosphate, and silicates such as sodium silicate. These resin materials are easily cured by heating and have excellent heat resistance. Therefore, ease of producing the dust core 11 and heat resistance thereof can be enhanced.

A ratio of the binder to the soft magnetic powder slightly varies depending on the target magnetic properties and mechanical properties of the dust core 11 to be manufactured, the acceptable eddy current loss, and the like, and is preferably about 0.3 mass % or more and 5.0 mass % or less, more preferably about 0.5 mass % or more and 3.0 mass % or less, and still more preferably about 0.7 mass % or more and 2.0 mass % or less. Accordingly, it is possible to obtain the coil component 10 having the excellent magnetic properties while sufficiently binding the particles of the soft magnetic powder to each other.

If necessary, various additives may be added to the mixture as necessary for any purpose.

Examples of a constituent material of the conductive wire 12 include a material having high conductivity, for example, a metal material including Cu, Al, Ag, Au, and Ni. An insulating film may be provided on a surface of the conductive wire 12 as necessary.

A shape of the dust core 11 is not limited to the ring shape shown in FIG. 1, and may be, for example, a shape in which a part of the ring is missing, or a shape in which a shape in a longitudinal direction is linear, or a sheet shape or a film shape.

The dust core 11 may contain, as necessary, a soft magnetic powder other than the soft magnetic powder according to the embodiment described above, or a non-magnetic powder.

### 3.2. Closed Magnetic Circuit Type

Next, a closed magnetic circuit type coil component, which is an example of the magnetic element according to the embodiment, will be described.

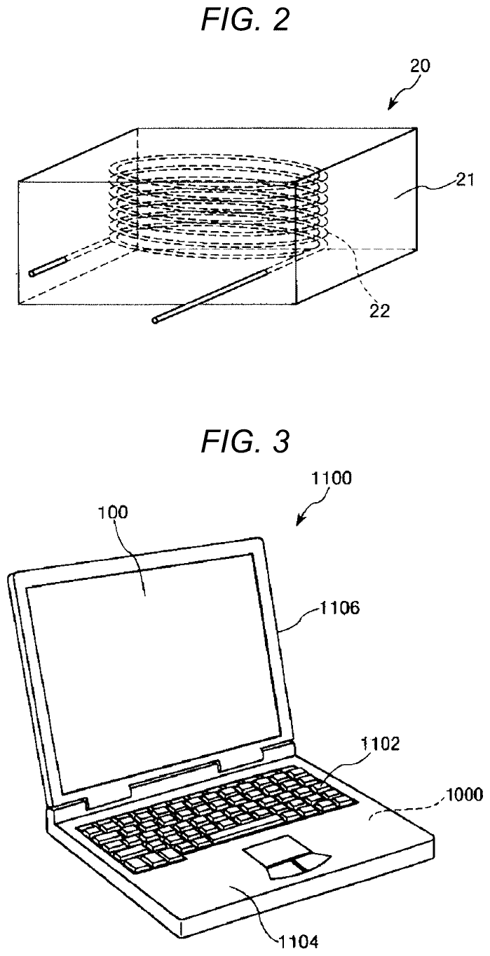

FIG. 2 is a transparent perspective view schematically showing a closed magnetic circuit type coil component.

Hereinafter, the closed magnetic circuit type coil component will be described. In the following description, differences from the toroidal type coil component will mainly be described, and description of similar matters will be omitted.

As shown in FIG. 2, the coil component 20 according to the embodiment is formed by embedding a conductive wire 22 formed in a coil shape inside a dust core 21. That is, the coil component 20 which is a magnetic element includes the dust core 21 containing the above-described soft magnetic powder, and is formed by molding the conductive wire 22 with the dust core 21. The dust core 21 has a configuration same as that of the dust core 11 described above. Accordingly, the dust core 21 having a high density can be implemented.

The coil component 20 having such a configuration is likely to have a relatively small size. Therefore, when the coil component 20 is mounted in an electronic device or the like, the electronic device or the like can have high performance and a small size.

Since the conductive wire 22 is embedded in the dust core 21, a gap is less likely to be formed between the conductive wire 22 and the dust core 21. Therefore, a vibration caused by magnetostriction of the dust core 21 can be prevented, and generation of noise due to the vibration can also be prevented.

A shape of the dust core 21 is not limited to the shape shown in FIG. 2, and may be a sheet shape, a film shape, or the like.

The dust core 21 may contain, as necessary, a soft magnetic powder other than the soft magnetic powder according to the embodiment described above, or a non-magnetic powder.

### 4. Electronic Device

Next, the electronic device including the magnetic element according to the embodiment will be described with reference to FIGS. 3 to 5.

FIG. 3 is a perspective view showing a mobile personal computer which is the electronic device according to the embodiment. A personal computer 1100 shown in FIG. 3 includes a main body 1104 including a keyboard 1102 and a display unit 1106 including a display 100. The display unit 1106 is pivotally supported by the main body 1104 via a hinge structure. Such the personal computer 1100 includes therein a magnetic element 1000 such as a choke coil, an inductor, or a motor for a switching power supply.

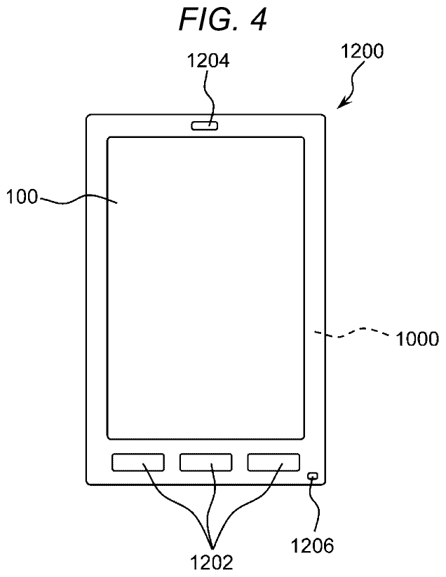

FIG. 4 is a plan view showing a smartphone which is the electronic device according to the embodiment. A smartphone 1200 shown in FIG. 4 includes a plurality of operation buttons 1202, an earpiece 1204, and a mouthpiece 1206. In addition, the display 100 is disposed between the operation buttons 1202 and the earpiece 1204. Such the smartphone 1200 includes therein the magnetic element 1000 such as an inductor, a noise filter, or a motor.

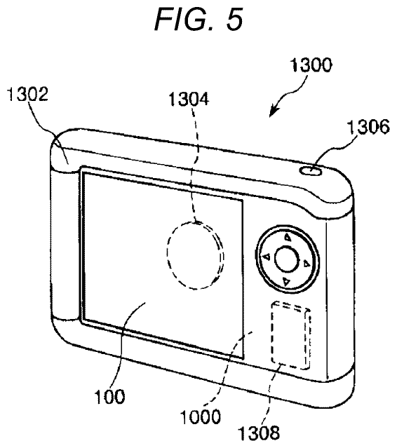

FIG. 5 is a perspective view showing a digital still camera which is the electronic device according to the embodiment. A digital still camera 1300 photoelectrically converts an optical image of a subject with an imaging element such as a charge coupled device (CCD) to generate an imaging signal.

The digital still camera 1300 shown in FIG. 5 includes the display 100 provided at a rear surface of a case 1302. The display 100 functions as a finder which displays a subject as an electronic image. A light receiving unit 1304 including an optical lens, a CCD, and the like is provided on a front surface side of the case 1302, that is, on a back surface side in the drawing.

When a photographer confirms a subject image displayed on the display 100 and presses a shutter button 1306, a CCD imaging signal at this time is transferred to and stored in a memory 1308. Such the digital still camera 1300 also includes therein the magnetic element 1000 such as an inductor or a noise filter.

Examples of the electronic device according to the embodiment include, in addition to the personal computer in FIG. 3, the smartphone in FIG. 4, and the digital still camera in FIG. 5, a mobile phone, a tablet terminal, a watch, inkjet discharge apparatuses such as an inkjet printer, a laptop personal computer, a television, a video camera, a video tape recorder, a car navigation apparatus, a pager, an electronic notebook, an electronic dictionary, a calculator, an electronic game console, a word processor, a workstation, a videophone, a security television monitor, electronic binoculars, a POS terminal, medical devices such as an electronic thermometer, a blood pressure meter, a blood glucose meter, an measurement apparatus, an ultrasonic diagnostic apparatus, and an electronic endoscope, a fish finder, various measuring devices, instruments for a vehicle, an aircraft, and a ship, vehicle control devices such as an automobile control device, an aircraft control device, a railway vehicle control device, and a ship control device, and a flight simulator.

Such an electronic device includes the magnetic element according to the embodiment, as described above. Accordingly, effects of the magnetic element according to the embodiment can be provided, and the electronic device can have high performance and a small size.

### 5. Effects of Embodiment

As described above, the soft magnetic powder according to the embodiment contains Fe as a main component, Si having a content of 2.5 mass % or more and 7.5 mass % or less, Cr having a content of 0.5 mass % or more and 10.0 mass % or less, Al having a content of 0.05 mass % or more and 0.50 mass % or less, C having a content of 0.005 mass % or more and 0.050 mass % or less, and impurities. In addition, in the soft magnetic powder according to the embodiment, when 0.5 g of the soft magnetic powder weighed is used as a test object, the test object is placed in a cylinder having an inner diameter of 8 mm and an axis in an up-down direction, and a withstand voltage is measured in a state in which a load of 20 kgf (196 N) is applied to the test object by sandwiching the test object between electrodes from above and below, the withstand voltage is 400 V or more.

According to such a configuration, it is possible to implement a soft magnetic powder capable of producing a green compact having high filling properties, good magnetic properties, and high voltage.

In the soft magnetic powder according to the embodiment, when a maximum magnetic moment measured using a vibrating sample magnetometer is Mm [emu/g] and a true density is ρ [g/cm³], a saturation magnetic flux density Bs obtained by Bs=4π/10000×ρ×Mm is preferably 1.80 T or more.

According to such a configuration, a soft magnetic powder capable of producing a magnetic element that is unlikely to be saturated even at a high current is obtained.

In the soft magnetic powder according to the embodiment, a classified product that is classified using a first sieve having an opening of 45 μm and passes through the first sieve is defined as −45 particles, the −45 particles are classified using a second sieve having an opening of 32 μm, a classified product remaining on the second sieve is defined as +32 particles, and a classified product passing through the second sieve is defined as −32 particles, and the −32 particles are classified using a third sieve having an opening of 16 μm, a classified product remaining on the third sieve is defined as +16 particles, and a classified product passing through the third sieve is defined as −16 particles. An average circularity of −45 particles is denoted by X, an average circularity of +32 particles is denoted by Y1, an average circularity of +16 particles is denoted by Y2, and an average circularity of −16 particles is denoted by Y3. At this time, the soft magnetic powder according to the embodiment preferably satisfies the following formulas (1), (2), and (3).

Y1=αX (1)

Y2=βX (2)

Y3=γX (3)

(A coefficient α in the above formula (1), a coefficient β in the above formula (2), and a coefficient γ in the above formula (3) are each 0.95 or more and 1.05 or less.)

According to such a configuration, a soft magnetic powder having particularly good filling properties is obtained.

In the soft magnetic powder according to the embodiment, a ratio of the content of C to the content of Al is preferably 0.010 or more and 0.250 or less.

According to such a configuration, it is possible to achieve both the spheroidization of the particles by the addition of Al and the optimization of the hardness of the particles by the addition of C with a more optimal balance. As a result, a soft magnetic powder having particularly good filling properties during compacting is obtained.

In the soft magnetic powder according to the embodiment, the Vickers hardness of a cross section of the particle is preferably 250 or more and 400 or less.

According to such a configuration, when the soft magnetic powder is compacted, a surface of the particle is appropriately easily deformed. Accordingly, the filling properties of the soft magnetic powder during compacting can be enhanced.

The dust core according to the embodiment includes the soft magnetic powder according to the embodiment.

According to such a configuration, a dust core having a high density is obtained.

The magnetic element according to the embodiment includes the dust core according to the embodiment.

According to such a configuration, a magnetic element having improved magnetic properties and capable of coping with a high voltage can be obtained.

An electronic device according to the embodiment includes the magnetic element according to the embodiment.

According to such a configuration, it is possible to obtain an electronic device having high performance and a small size.

The soft magnetic powder, the dust core, the magnetic element, and the electronic device of the present disclosure are described above based on the preferred embodiment, and the present disclosure is not limited thereto. For example, shapes of the dust core and the magnetic element are not limited to those shown in the drawings, and may be any shapes.

### EXAMPLES

Next, specific examples of the present disclosure will be described.

### 6. Production of Soft Magnetic Powder

### 6.1. Sample No. 1

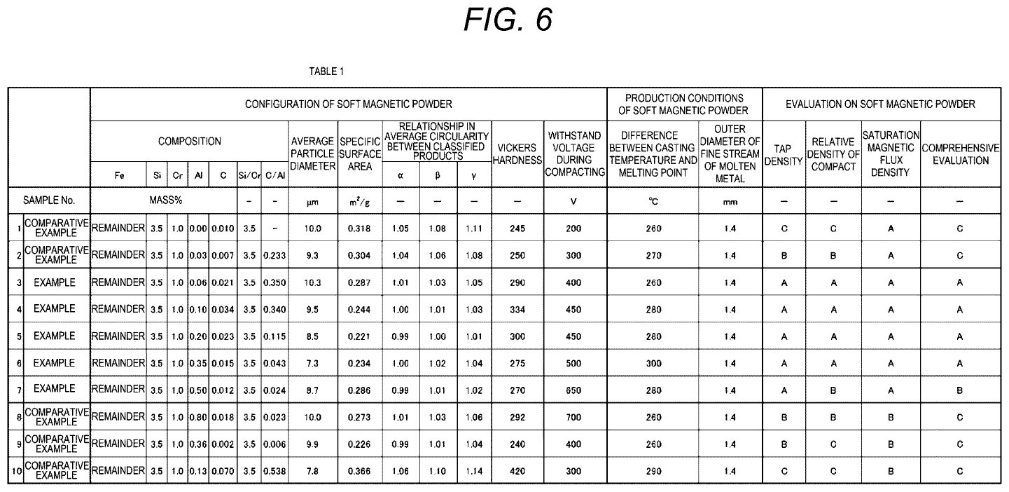

First, a soft magnetic powder was obtained using a water atomization method. A composition of the obtained soft magnetic powder is as shown in Table 1 (FIG. 6). Production conditions (difference between a casting temperature and a melting point) of the soft magnetic powder by the water atomization method are shown in Table 1. FIG. 6 shows Table 1 indicating configurations, production conditions, and evaluation results of soft magnetic powders of respective sample Nos.

In addition, for the obtained soft magnetic powder, an average particle diameter, a specific surface area, a relationship of the average circularity between classified products, and the Vickers hardness were measured. Measurement results are shown in Table 1. A relationship between the average circularities of the classified products is represented by the coefficients α, β, and γ of the above-described formulas (1) to (3). The average circularity X was 0.88.

### 6.2. Sample Nos. 2 to 17

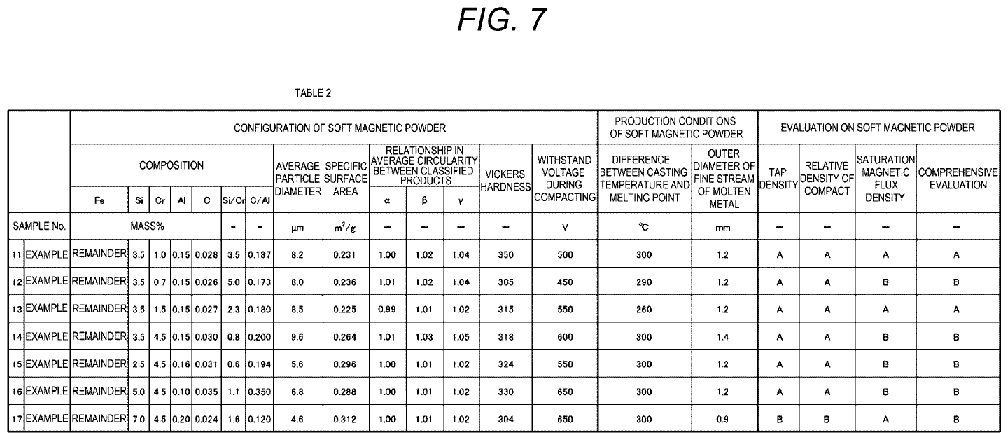

Soft magnetic powders were obtained in the same manner as in Sample No. 1 except that compositions of the soft magnetic powders were changed as shown in Table 1 (FIG. 6) or Table 2 (FIG. 7). The average circularity X of the soft magnetic powder of each Sample No. was within the range of 0.85 to 0.90. FIG. 7 shows Table 2 indicating the configurations, the production conditions, and the evaluation results of the soft magnetic powders of respective sample Nos.

In Tables 1 and 2, among the soft magnetic powders of the respective sample Nos., those corresponding to the present disclosure are “Examples”, and those not corresponding to the present disclosure are “Comparative Examples”.

### 7. Evaluation on Soft Magnetic Powder

### 7.1. Tap Density of Soft Magnetic Powder

The tap density of the soft magnetic powder of each sample No. was measured. Then, the measurement results were evaluated in three stages A to C in light of the following evaluation criteria. The evaluation results are shown in Tables 1 and 2.
A: The tap density is 4.65 g/cm³ or more and 5.00 g/cm³ or less.
B: The tap density is 4.50 g/cm³ or more and 5.10 g/cm³ or less (excluding the range of A).
C: The tap density is less than 4.50 g/cm³ or 5.10 g/cm³ or less.

### 7.2. Relative Density of Green Compact of Soft Magnetic Powder

For the soft magnetic powder of each sample No., a relative density of the green compact formed by compacting at a pressure of 588.4 MPa was measured. Then, the measurement results were evaluated in three stages A to C in light of the following evaluation criteria. The evaluation results are shown in Tables 1 and 2.
A: The relative density of the green compact is 80.0% or more and 85.0 or less.
B: The relative density of the green compact is 79.0% or more and less than 80.0% or more than 85.0%.
C: The relative density of the green compact is less than 79.0%.

### 7.3. Saturation Magnetic Flux Density of Soft Magnetic Powder

The saturation magnetic flux density of the soft magnetic powder of each sample No. was measured. Then, the measurement results were evaluated in three stages A to C in light of the following evaluation criteria. The evaluation results are shown in Tables 1 and 2.
A: The saturation magnetic flux density is 1.90 T or more.
B: The saturation magnetic flux density is 1.80 T or more and less than 1.90 T.
C: The saturation magnetic flux density is less than 1.80 T.

### 7.4. Comprehensive Evaluation

The soft magnetic powder of each sample No. was comprehensively evaluated based on the measurement result of a withstand voltage during compacting and the evaluation results of the relative density and the saturation magnetic flux density of the green compact. The evaluation criteria for the comprehensive evaluation are as follows. The evaluation results are shown in Tables 1 and 2.
A: The withstand voltage is 400 V or more, and the evaluation results of the relative density and the saturation magnetic flux density of the green compact are both A.
B: The withstand voltage is 400 V or more, at least one of the evaluation results of the relative density and the saturation magnetic flux density of the green compact is B, and the remainder is A.
C: The withstand voltage is lower than 400 V, or both the evaluation results of the relative density and the saturation magnetic flux density of the green compact are B, or at least one is C.

As shown in Tables 1 and 2, it is found that the soft magnetic powder of each example has high filling properties and can produce a green compact having a high density, and can produce a green compact having good magnetic properties and capable of coping with a high voltage.

What is claimed is:

1. A soft magnetic powder comprising:
Fe as a main component;
Si having a content of 2.5 mass % or more and 7.5 mass % or less;
Cr having a content of 0.5 mass % or more and 10.0 mass % or less;
Al having a content of 0.05 mass % or more and 0.50 mass % or less;
C having a content of 0.005 mass % or more and 0.050 mass % or less; and
an impurity, wherein
when 0.5 g of the soft magnetic powder weighed is used as a test object, the test object is placed in a cylinder having an inner diameter of 8 mm and an axis in an up-down direction, and a withstand voltage is measured in a state in which a load of 20 kgf (196 N) is applied to the test object by sandwiching the test object between electrodes from above and below, the withstand voltage is 400 V or more.

2. The soft magnetic powder according to claim 1, wherein
a saturation magnetic flux density Bs obtained by Bs=4π/10000×ρ×Mm is 1.80 T or more,
where Mm [emu/g] is a maximum magnetic moment measured using a vibrating sample magnetometer, and ρ [g/cm³] is a true density.

3. The soft magnetic powder according to claim 1, wherein
when a classified product that is obtained by classification using a first sieve having an opening of 45 μm and that passes through the first sieve is defined as −45 particles,
the −45 particles are classified using a second sieve having an opening of 32 μm, a classified product remaining on the second sieve is defined as +32 particles, and a classified product passing through the second sieve is defined as −32 particles, and
the −32 particles are classified using a third sieve having an opening of 16 μm, a classified product remaining on the third sieve is defined as +16 particles, and a classified product passing through the third sieve is defined as −16 particles,
the following formulas (1), (2), and (3) are satisfied,
Y1=αX (1),
Y2=βX (2), and
Y3=γX (3),
where X is an average circularity of the −45 particles,
Y1 is an average circularity of the +32 particles,
Y2 is an average circularity of the +16 particles,
Y3 is an average circularity of the −16 particles, and
the coefficient α in the formula (1), the coefficient β in the formula (2), and the coefficient γ in the formula (3) are each 0.95 or more and 1.05 or less.

4. The soft magnetic powder according to claim 1, wherein
a ratio of the content of C to the content of Al is 0.010 or more and 0.250 or less.

5. The soft magnetic powder according to claim 1, wherein
a Vickers hardness of a cross section of a particle is 250 or more and 400 or less.

6. A dust core comprising:
the soft magnetic powder according to claim 1.

7. A magnetic element comprising:
the dust core according to claim 6.

8. An electronic device comprising:
the magnetic element according to claim 7.
